(19) United States
(12) Patent Application Publication
(10) Pub. No.: US 2006/0004838 A1
(43) Pub. Date: Jan. 5, 2006

(54) Sharing large objects in distributed systems

(75) Inventors: Neeraj Pradip Shodhan, Mountain View, CA (US); Goutam Kulkarni, Nashua, NH (US); Lewis Kaplan, Los Angeles, CA (US); Anand Lakshminath, Fremont, CA (US); Yuhong Gu, Nashua, NH (US); Joydip Kundu, Derry, NH (US)

Correspondence Address: HICKMAN PALERMO TRUONG & BECKER, LLP, 2055 GATEWAY PLACE, SUITE 550, SAN JOSE, CA, 95110, US

(73) Assignee: ORACLE INTERNATIONAL CORPORATION, REDWOOD SHORES, CA (US)

(21) Appl. No.: 10/918,023

(22) Filed: Aug. 12, 2004

Related U.S. Application Data
(60) Provisional application No. 60/571,300, filed on May 14, 2004.

(51) Int. Cl. G06F 17/00

(52) U.S. Cl. 707/102

(57) ABSTRACT

A system and method for efficiently sharing Large Objects (LOBs) is disclosed. Historical records (e.g., redo logs) are kept in which a marker is placed prior to the LOB. The marker includes identifying information, such as the row-column intersection. Using the identifying information in the marker, the LOB may be shared with other systems without staging the LOB at a source database system, prior to transporting the LOB from the source database system to the destination database system. Additionally, using the identifying information, the LOB may be accessed and manipulated prior to being consumed at the destination system.

### CROSS REFERENCE TO RELATED APPLICATIONS; PRIORITY CLAIM

This application claims benefit of Provisional Application No. 60/571,300, entitled “Sharing Large Objects in Distributed Systems”, filed May 14, 2004 by Neeraj Pradip Shodhan, et al. the entire contents of which is hereby incorporated by reference as if fully set forth herein, under 35 U.S.C. §119(e).

The present application is related to U.S. application Ser. No. 10/449,873, entitled “Utilizing Rules in a Distributed Information Sharing System”, filed on May 30, 2003 by Edwina Lu, et al., the contents of which are herein incorporated by reference.

### FIELD OF THE INVENTION

The invention relates to sharing data. More specifically, the invention relates to sharing large objects.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, unless otherwise indicated, it should not be assumed that a problem has been recognized by the prior art merely because the problem is discussed in this section.

For convenience of expression, various entities that represent sets of instructions (e.g., functions and queries) are described as performing actions, when in fact, a computer, process, database server, or other executing entity performs those actions in response to executing or interpreting the set of instructions. For example, a function may be described as determining that a condition exists or a query may be described as accessing information. These are just convenient ways of expressing that a computer, process, database server or other executing entity is determining that a condition exists in response to executing a function or is accessing data in response to executing or computing a query.

A database server, also referred to as a Database Management System (DBMS), retrieves and manipulates data in response to receiving a database statement. A database server is used for storing and organizing information on persistent electronic data storage medium, such as a hard disk or a tape in a consistent and recoverable manner. As more and more data is being stored electronically in computer systems, for high availability, scalability, load balancing, disaster recovery, for example, data is captured and shared in distributed systems, such as a database.

A distributed system consists of inter-connected multiple computer systems that are capable of communicating with each other via a network connection. Large Objects (LOBs) are objects of any sort containing large amounts of data. LOBs may be any one of, or any combination of data used for images, sounds, or text. In a database a LOB may be stored within a field in a record.

Due to the large size and storage requirements of LOBs, capturing and sharing of LOBs in distributed systems is particularly challenging. There are several ways in which one can share information in a distributed system. Data can be shared by copying data bytes from the physical storage medium (e.g., a hard disk or a tape). However, copying from the physical storage medium is not flexible in the selectivity with which data can be shared within a distributed environment. When sharing via the method of copying data, typically, all of the data is shared among all computers regardless of whether the data is of interest to each computer. Also, using the copying method it is difficult to share data between systems that differ in character sets and storage formats, for example.

Another mechanism for sharing data relies on database triggers. In creating a database trigger, an event is registered with the database server. When that event occurs a notification of the occurrence of the event is issued. In response to the notification, one or more components of the system take a particular action based on the event. In order to use the trigger for sharing a LOB, the particular action taken is the recording of the event at a location followed by the distribution of the information recorded.

Mechanisms of sharing that use database triggers to capture changes consume additional resources at the source database system. When using database triggers, LOBs are dealt with as a single portion of data, which results in a higher latency than were the data not dealt with as a single portion of data. Thus, the overhead associated with database trigger sharing can be quite substantial, especially when dealing with LOBs.

Another approach for sharing information is the log based approach, which uses a redo log. A redo log contains records that specify changes to records in tables maintained by a database system.

A log based capture mechanism uses information recorded in the redo logs to capture data in a distributed system. Changes that are captured from the redo logs are staged in a staging area as Logical Change Records (LCRs). When using the redo logs for sharing data, logical change records derived from the redo log are read in sequence, and propagated to the destination system, where the logical change records are eventually consumed and applied. In this specification, consuming a record by a database system refers to making changes to the data stored on the database system that reflect the changes in the redo and/or other historical records.

When a LOB is stored in a database system, based on the size, the LOB may get recorded in multiple portions in multiple log records. LOB identifying information is recorded at the end of the LOB. By storing LOBs in multiple portions, the LOBs can be read faster from the disk and the LOBs do not have to be stored contiguously on the disk. LOB identifying information is information such as the transaction the LOB belongs to, the offset of data within the LOB, the total length of the LOB, and information regarding which row the LOB belongs to. When a LOB is recorded in a redo log, each portion may be stored in a redo record. Each redo record contains a portion of LOB data, and information identifying the LOB data portion. For example, the byte stream associated with the data recorded in that LOB portion and a unique identifier associated with a LOB column may be recorded with a LOB data portion. However, data from multiple LOBs may be interleaved with each other within the redo log. Although multiple LOBs can be staged in parallel by a capture (e.g., a logminer) mechanism, the parallel staging is possible because the capture mechanism mines the redo logs based on various physical properties recorded in the redo log. The LOBs cannot be sent to the destination until the identifying information is obtained so that the LOB can be identified in terms of where the LOB belongs in the table or other database object. Some of the information, such as the transaction identification, offset, and length, may be derived from other auxiliary redos. Even after gathering the information from the auxiliary redos, information such as other fields from the row record that contains the LOB may be necessary before a decision can be made regarding what destination to send the LOB, if any.

LOB identifying information, which describes and identifies the LOB data portion, is typically recorded at the end of a LOB. Therefore, in the redo log, for example, the identifying information appears as one of the very last redo records of the LOB. Consequently, the entire LOB data needs to be read and staged by the data capture mechanism before determining whether to propagate the LOB.

The difficulties associated with staging LOBs are greater if the user is not interested in capturing data from one or more of the LOBs being staged. In this case the capture mechanism is forced to stage one or more entire LOBs, only to eventually discard the LOBs, which wastes buffer space and processing time staging the LOB.

Thus, since the LOB data portions are not identified until the last data portion has been captured, if several LOBs are interleaved, they must be staged concurrently, before being sent. Specifically, even though data portions from multiple LOBs can be interleaved in the redo log, they all have to be staged first and propagated to the destination one LOB at a time. Staging the LOBs concurrently further delays sending each of the interleaved LOBs. After staging each of the interleaved LOBs, it may be discovered that some of the staged LOBs are not of interested, and the capturing and staging of those LOBs wastes CPU time.

LOBs can contain text data in one of the many character sets having different storage formats. It is advantageous to perform some translation of the data portions as they are received. However, if LOB data is recorded in multiple redo records, and if a single character in that character set is represented by one or more bytes of data, there is a possibility that a single character can get split between multiple data portions. In a distributed system, logical change records that could contain partial character data portions cannot be understood and used, and therefore cannot be translated from one character set to the other. At intermediate nodes and destinations, partial characters cannot be interpreted, and may appear as noise. Therefore, independent access to data portions containing partial character sets at intermediate nodes or destinations is prevented.

In view of the above, there is a need for a better manner of sharing LOBs that at least partially alleviates one or more of the above problems.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for transporting LOBs between two systems.

FIG. 2 is a block diagram of a flowchart for a method for storing LOBs using the system of FIG. 1.

FIG. 3 is a block diagram of a flowchart for a method for transporting LOBs using the system of FIG. 1.

FIG. 4 is a block diagram that illustrates a computer system that may be used in implementing an embodiment of the present invention.

### DETAILED DESCRIPTION OF THE INVENTION

A method and apparatus for sharing LOBs between systems is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature may not address any of the problems discussed above or may only address one of the problems discussed above. Some of the problems discussed above may not be fully addressed by any of the features described herein. Although headings are provided, information related to a particular heading, but not found in the section having that heading, may also be found elsewhere in the specification.

Functional Overview

In an embodiment, a log based sharing mechanism is used for sharing LOBs. The data portions in the redo log in which the LOB data is stored are preceded by information needed to identify the LOB to which they belong. Preceding a LOB with information to identify the LOB allows the subsequent data portions (e.g., data pieces) of that LOB that are in the redo log to be identified without any delay. In an embodiment, the information placed prior to the LOB and identifying the LOB is a minimal or relatively small set of identifying information. In an embodiment, the identifying information is placed in a marker, which may be a redo record that precedes the first redo record of the LOB. In an embodiment of the present invention, the redo logs are used for sharing LOBs in platform independent manner. In an embodiment, at least some data identifying the LOB is placed prior to the stream of data in which a LOB is being sent.

Identifying Information

In an embodiment, the identifying information may be placed in a log record (e.g., a marker) prior to any log records used to store a LOB. One or more log records containing identifying information is also placed at the end of the LOB to facilitate any recovery mechanism reading the changes in the sequence in which the changes occurred. In an embodiment, the set of identifying information in the marker is a minimal set of information (e.g., the smallest set of information necessary for the destination and source data systems to uniquely and identify the LOB). In an embodiment, a mechanism is included allowing users associated with the destination and/or source database systems to specify the identifying portions of information that are stored in the marker and/or sent to the destination dataset system. For example, a user associated with the source database system may be able to specify which portions of data are included in the marker. In an embodiment, a primary key of the record that holds the LOB is stored in the marker.

Using the identifying information in the marker, the source database system may determine identifying information that is relevant to the destination database system. The source database system may send the identifying information that is relevant to the destination database system with each portion of the LOB to aid in manipulating and consuming the portions of the LOB. In an embodiment, the user has the option of changing the name of the LOB (e.g., a table or column) or other values associated with the LOB (e.g., column values) once the LOB is placed into a stream of data.

Consuming LOBs

In an embodiment of the invention, a capture mechanism is used to generate logical change records in the order that the changes are recorded in the redo log without staging the entire LOB data, which reduces the consumption of resources, such as memory, physical storage space, and CPU time. In this specification staging a LOB refers to re-creating a single LOB from multiple pieces of LOB data. In the prior art, staging was always performed prior to sending a LOB to the destination database system. Generating logical change records in the order received allows the capture mechanism to generate and stream interleaved logical change records for multiple LOBs. An embodiment of the present invention allows data portions of LOBs to be consumed independently of other LOBs. Consuming the LOB may involve storing the LOB or sending the LOB to another system. An example of such a consumer is the Oracle streams apply mechanism. In an embodiment of the present invention, the LOB may be staged at the destination database system, allowing users to access its contents as a single LOB prior to consumption.

Filtering and Manipulating LOB Portions

Since each LOB data portion (e.g., each LOB data piece) can be identified, all the uninteresting LOB data (e.g., LOB data belonging to LOBs that were not requested) can be filtered out without being staged and without thereby consuming resources that unnecessarily and/or adversely affect the performance. Also, logical change record contents can be accessed and transformed independently in the data stream. Using the identifying information sent in the stream (based on the identifying information in the marker) accessing and transforming logical change records can be performed at any intermediate hop or at the destination. An example of an accessing and transforming task is renaming the LOB. Also, in an embodiment, LOB data portions can be applied without staging the LOB at the destination or the source database system, because the identifying information allows the LOB portions (e.g., LOB pieces) to be identified as belonging to the LOB. As another example of accessing and transforming tasks, consider a table that has a column containing a LOB and another column containing a country code. The country code may be stored as a part of the identifying information. Based on the country code, LOBs can be filtered out without staging if they belong to a particular country. Also, based on the country code, currency stored inside LOBs can be changed. For example, Dollars may be converted to Yen based on a country code. All logical change records containing LOBs for Asian countries may be sent to an intermediate node where a decision may be made to select the destination based on the country code.

In an embodiment, logical change records containing LOB data can be consumed independently without having to wait for the last data portion. In an embodiment, logical change records containing portions of LOBs can be accessed and transformed independently. The logical change records containing portions of LOBs can also be reassembled if needed. This provides additional flexibility for application developers.

Partial Character Sets

When a character is represented by two or more bytes, at times a character can get divided between consecutive log records, resulting in each of the consecutive records having only a part of the character. In other words, each of the consecutive records includes a partial character. In an embodiment, a partial character at the end of a LOB data portion is stored in memory and added at the beginning of the next LOB data portion so that the LOB may form a complete character. Storing the partial character at the beginning of the next data portion facilitates ensuring that logical change record never contains partial data. Since the partial data is absent, the sharing of LOBs is still possible when the source and destination have different character sets, and characters can be interpreted without the partial character data being confused with noise.

Manipulating Data of the LOB

In an embodiment, if required, the capture mechanism also manipulates data according to the storage format of the source database system. Using the storage format of the source database system to manipulating data facilitates the sharing of LOBs between systems with different character sets (e.g., Japanese and English), and/or storage formats (e.g. Little Endian and Big Endian), for example.

In an embodiment of the invention, the apply mechanism is provided with an option for reassembling portions of a LOB into a single portion at the destination database system. For example, the apply mechanism or other tool may stage the LOB at the destination database system, before consuming the LOB. Consuming a LOB means to determine what to do or how to handle the LOB, and based on the determination performing any operations that need to be performed and/or changing any parameters that need to be changed in order to handle the LOB. After staging the LOB at the destination, the LOB may be edited or otherwise manipulated before being consumed.

Handling a Failure that Occurs in the Middle of a Capture

If during a capture process a failure occurs at the source database system in which the captured portions of the LOB were lost, in the prior art none of the LOB would have been sent. Consequently, it would have been necessary to restart the capture process. However, by placing a marker marking the beginning of the LOB in the redo record, the portions of the LOB may be sent as the portions of the LOB are captured. Consequently, if there is a failure at the source database system, the capture process does not have to restart from the beginning of the LOB, but can return to the last portion of the LOB or other data that was not sent.

An Embodiment of a System that Shares LOBs

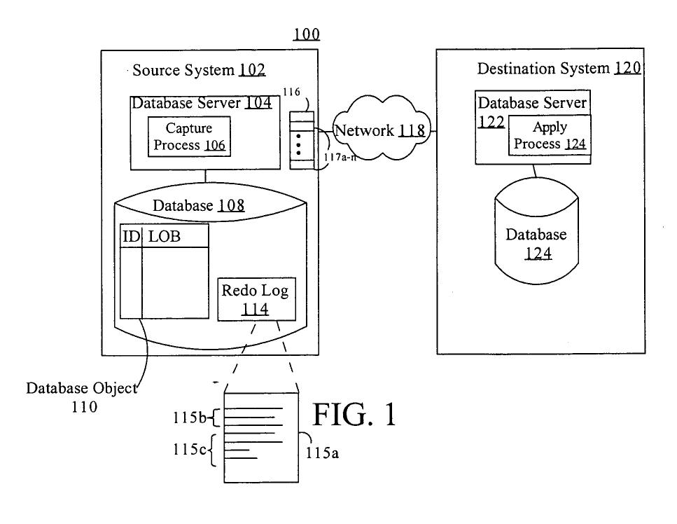

FIG. 1 is a block diagram of an embodiment of a system 100 in which the invention may be implemented. System 100 includes source database system 102 having database server 104 with capture process 106. Source database system 102 also includes database 108 having database object 110, redo log 114, and redo log potion 115a with LOB identifier 115b and LOB data 115c. Source database system also includes queue 116 having logical change records 117a-n. System 100 also includes network 118 and destination database system 120. Destination database system 120 includes database server 122 having apply process 124. Additionally destination database system 120 includes database 126. In alternative embodiments, system 100 may not have all of the components listed above or may have other components instead of and/or in addition to those listed above. In an embodiment, system 100 is a distributed database system. Alternatively, system 100 may be any network of systems in which a LOB is being shared. In an embodiment, sharing LOBs includes storing the LOBs in a manner in which the LOBs can be captured and transported dynamically. Although FIG. 1 shows only one destination system, system 100 may have any number of destination systems sharing data that may include one or more LOBs.

Source database system 102 may be a machine or network of machines supporting a source database. The source database system 102 is the source of a LOB that is being shared with one or more other systems.

Database server 104 is software and/or hardware that accesses the source database. Queries and other database commands are submitted to database server 104, which processes the commands and returns or manipulates data in the source database in response to the database commands. Capture process 106 captures (e.g., extracts and/or reconstructs) data from redo logs. Capture process 106 is capable of capturing LOBs from one or more redo logs. In alternative embodiments, capture process 106 may capture LOBs and/or other data from other historical records (e.g., undo logs) from which it is possible to derive enough information for reconstructing data such as LOBs. The other historical records may be used instead of or in combination with the redo logs. Although capture process 116 is indicated as being part of database server 114, in alternative embodiments, capture process 116 may be a separate portion of software and/or hardware, and may be located elsewhere.

Database 108 is the source database that contains one or more LOBs that are being shared. Database 108 is accessed via database server 104. Database object 110 may be any object in database 108 in which data is stored that includes one or more LOBs. For example, database object 110 may be a table that includes the one or more LOBs being shared. The LOBs may be one portion of database object 110, such as one or more columns of a table within database object 110. Database 108 may also include a series of other tables supporting database object 110. Alternatively, database object 110 may be a set of LOBs stored individually and not specifically stored in tables, a set of one or more tables in which each table contains one or more LOBs, or a set of tables in which each table is a LOB.

Changes that are made to database object 110 are recorded in a redo log. Redo log 114 includes the changes made to database object 110. Redo log 114 may include records that store either the actual change or an indication the operations necessary to create the corresponding change. Redo log portion 115a is a portion of redo log 114, and includes LOB identifier 115b and LOB data 115c.

In an embodiment, LOB identifier 115b is placed before LOB data 115c to facilitate dynamically identifying LOB data 115c as LOB data while LOB data 115c is being retrieved. LOB identifier 115b may contain information, such as information identifying a cell of a table containing the LOB (e.g., row-column intersection information). The LOB identifier identifies a LOB so that the LOB portions that follow may be identified.

LOB data 115c data may include a portion of LOB data and information identifying the LOB data portion. For example, the information identifying the LOB may include the byte stream associated with the data stored in that LOB portion and a unique identifier associated with that LOB column. There may be several portions of LOB data 115c, which may be interleaved with other data. In an embodiment, LOB data 115c also includes further identifying information in the last portion of the LOB or following the last portion of the LOB. For example, the last portion of LOB data 115c may include the transaction changing the LOB, the offset within the LOB of the byte stream in a given portion of the LOB, the total length of the LOB, and information regarding which row the LOB belongs to. The last portion of LOB data 115c may contain information identifying the LOB, such as the information identifying a cell of a table containing the LOB and/or other identifying information. The last portion of LOB data 115c may contain all of the or any part of the information included in LOB identifier 115b.

Queue 116 is a queue of logical change records waiting to be sent to the destination database system. Logical change records 117a-n are the logical change records waiting to be sent to the destination database system. Logical change records 117a-n include LOB data portions (and may include other data) that were captured by capture process 106 from redo log 114.

Network 118 can be a Local Area Network (LAN), a Wide Area Network (WAN) and/or a direct connection. LOBs being shared are transported, as logical change records, across network 118. LOBs may be transported across network 118 as a stream of data portions having other data (e.g., other LOBs or other chunks of data) interleaved with portions of the LOB. In an embodiment, each LOB in the stream may be preceded with information informing the destination database system that a LOB is being sent, which may further include information about which LOB is being sent. In an embodiment, each portion of the LOB is sent with identifying information requested by the destination database system.

Destination database system 120 is the destination to which the LOB is being transported, and is one system that is sharing the LOB. There may be any number of other systems attached to network 118 that share LOBs with source database system 102. Database server 120 is the software and/or hardware that accesses the destination database. Queries and other database commands are submitted to database server 122, which processes the commands and returns or manipulates data in the destination database in response to receiving the database commands. Database server 122 may have a capture process instead of or in addition to capture process 106. Apply process 124 may be the part of database server 122 that process and stores a LOB that is sent from database 108 to destination database system 120. Apply process 124 reads any information that may have been sent indicating that a LOB was sent in the stream of data sent over network 118. Apply process 124 identifies the portions of the LOB sent as portions of the LOB are received. Destination database 126 is the destination to which LOBs are transported.

Example of a Method of Sharing LOBs

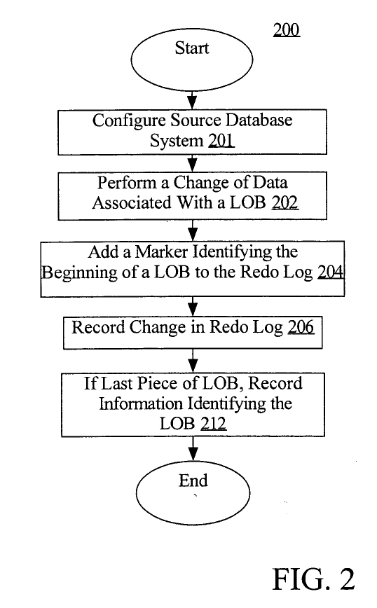

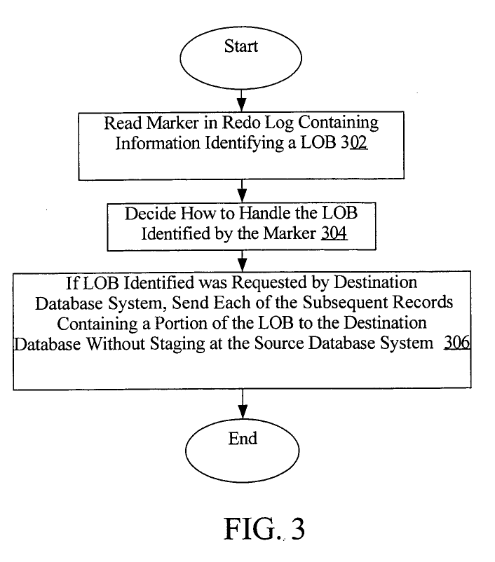

Sharing LOBs may include two parts. In a first part illustrated in FIG. 2 a LOB is stored. In a second part, illustrated in FIG. 3, a LOB is transported.

FIG. 2 is a block diagram of a method 200 for storing LOBs. In step 201, the source database system is configured for sending LOBs without first staging the LOBs. The configuring may include determining or specifying the identifying information that will be included in the markers of the LOBs stored in the source database system 102, and the identifying or specifying information that will be sent with the logical change records containing the LOBs to the destination database system 120. In step 202, a change to a LOB is made. The change may be a modification to an existing LOB or the creation of a LOB. In step 204, a record (e.g., a marker such as LOB identifier 115b) is stored in redo log 114 identifying that LOB data is held in log records that follow the marker. In step 206, the LOB is stored in one or more log records in redo log 114 as LOB data 115c. In step 212, if the portion of the LOB being recorded is the last portion of the LOB, identifying information is included in LOB data 115c. The identifying information in the last portion of the LOB may include the same identifying information as is contained in LOB identifier 115b and/or additional identifying information. Steps 206 and 212 may be performed concurrently or in any order with respect to one another. Method 200 is not limited to the order of the steps listed above. In alternative embodiments, method 200 may not include all of the steps listed above or may include other steps in addition to or instead of those steps listed above.

FIG. 3 is a block diagram of a method 300 for transporting LOBs. In step 302, a marker in a redo log is read that includes information identifying a LOB. In step 304, a decision is made how to handle subsequent records related to the LOB identified in the marker. For example, the decision may be to discard subsequent records in the redo log related to the LOB, or the decision may be to send a copy of a set of subsequent records related to the LOB to a destination database system. In step 306, if the LOB of the marker is of interest, subsequent records of the LOB are read and sent to the destination database system without staging the LOB. Method 300 is not limited to the order of the steps listed above. In alternative embodiments, method 300 may not include all of the steps listed above or may include other steps in addition to or instead of those steps listed above.

Hardware Overview

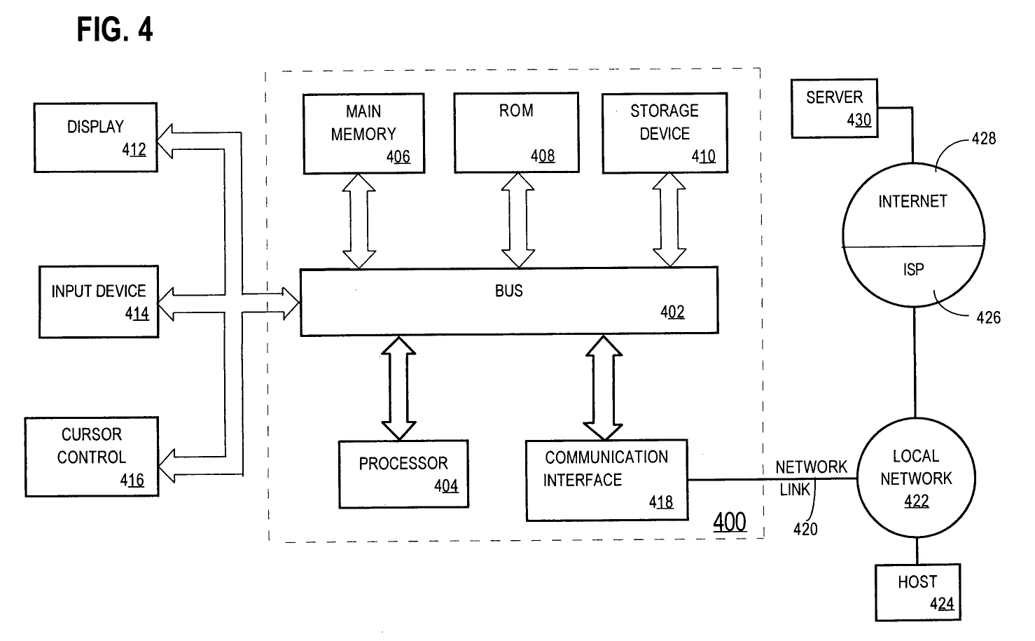

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of a machine such as computer system 400 for any of the machines of source database system 102, network 118, and destination database 120. According to one embodiment of the invention, methods 200 and 300 are provided by a machine, such as computer system 400, in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein is an example of a machine-readable medium, and refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application provides for sharing LOBs as described herein.

The received code may be executed by processor 404 as it is received, and/or stored in storage device 410, or other non-volatile storage for later execution. In this manner, computer system 400 may obtain application code in the form of a carrier wave. In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed:

1. A machine-implemented method for sharing large objects comprising:
recording in a redo log a first set of one or more records describing at least identifying information of a large object prior to storing a second set of one or more records that include at least a portion of content of the large object; and
determining how to process the second set based on the first set.

2. The method of claim 1, wherein the one or more records includes only the identifying information.

3. The method of claim 1, further comprising:
receiving from a user a specification of the identifying information to include in the first set of information that identifies the second set.

4. The method of claim 1, wherein the identifying information includes an identifier of a portion of a row record associated with the large object.

5. The method of claim 1, wherein the identifying information includes an identifier of a portion of a table associated with the large object.

6. The method of claim 1, wherein the determining includes at least determining to send the second set of one or more records to a destination database system.

7. The method of claim 1, wherein a first portion of data for a character is stored in a first record of the one or more records and a second portion of data for the character is stored in a second record of the one or more records, and the method further comprises:
determining the character based on the first record and the second record.

8. The method of claim 1, further comprising
sending the second set of one or more records to a destination database system; and
accessing and transforming the second set of one or more records after the sending and prior to consuming the second set of one or more records at the destination database, based on the information.

9. The method of claim 1, further comprises, based on the determining, discarding the second set of one or more records prior to capturing a last portion of the large object.

10. The method of claim 1, further comprises, based on the determining, discarding the second set of one or more records without staging the large object.

11. The method of claim 1,
wherein the redo log is associated with a source database system, and
wherein the method further comprises:
capturing the second set of one or more records, based on the determining;
sending the second set of one or more records to a destination database system, based on the determining;
detecting that a problem occurred at the source database system after the second set of one or more records was sent, wherein the problem occurred prior to a last portion of the large object being sent;
wherein the capturing changes and the sending are not repeated for records belonging to the second set of one or more records that were already sent.

12. A machine-readable medium carrying information comprising:
a log including at least a log of changes made to information stored in a database;
one or more portions of data associated with a large object stored in the database; and
a marker including at least information identifying the large object, wherein
the marker is located within the log prior to the one or more portions of data

13. The machine readable medium of claim 12, wherein the marker does not indicate a change made to information stored in the database.

14. A machine-readable medium carrying one or more sequences of instructions, which when executed by one or more processors, causes the one or more processors to perform a method comprising:
recording in a redo log a first set of one or more records describing at least identifying information of a large object prior to storing a second set of one or more records that include at least a portion of content of the large object; and
determining how to process the second set based on the first set.

15. The machine readable medium of claim 14, wherein the one or more records includes only the identifying information.

16. The machine-readable medium of claim 14, wherein the method further comprises:
receiving from a user a specification of the identifying information to include in the first set of information that identifies the second set.

17. The machine-readable medium of claim 14, wherein the identifying information includes an identifier of a portion of a row record associated with the large object.

18. The machine-readable medium of claim 14, wherein the identifying information includes an identifier of a portion of a table associated with the large object.

19. The machine-readable medium of claim 14, wherein the determining includes at least determining to send the second set of one or more records to a destination database system.

20. The machine-readable medium of claim 14, wherein a first portion of data for a character is stored in a first record of the one or more records and a second portion of data for the character is stored in a second record of the one or more records, and the method further comprises:
determining the character based on the first record and the second record.

21. The machine-readable medium of claim 14, wherein the method further comprises:
sending the second set of one or more records to a destination database system; and
accessing and transforming the second set of one or more records after the sending and prior to consuming the second set of one or more records at the destination database, based on the information.

22. The machine-readable medium of claim 14, wherein the method further comprises, based on the determining, discarding the second set of one or more records prior to capturing a last portion of the large object.

23. The machine-readable medium of claim 14, wherein the method further comprises, based on the determining, discarding the second set of one or more records without staging the large object.

24. The machine-readable medium of claim 14,
wherein the redo log is associated with a source database system, and
wherein the method further comprises:
capturing the second set of one or more records, based on the determining;
sending the second set of one or more records to a destination database system, based on the determining;
detecting that a problem occurred at the source database system after the second set of one or more records was sent, wherein the problem occurred prior to a last portion of the large object being sent;
wherein the capturing changes and the sending are not repeated for records belonging to the second set of one or more records that were already sent.
